(19) United States
(12) Patent Application Publication
(10) Pub. No.: US 2004/0193584 A1
(43) Pub. Date: Sep. 30, 2004

(54) Method and device for relevant document search

(76) Inventors: Yuichi Ogawa, Yokohama (JP); Tadataka Matsubayashi, Kawasaki (JP); Shinya Yamamoto, Kobe (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/671,718

(22) Filed: Sep. 29, 2003

(30) Foreign Application Priority Data
Mar. 28, 2003 (JP) 2003-089633

(51) Int. Cl. G06F 17/30

(52) U.S. Cl. 707/3

(57) ABSTRACT

Character strings are extracted from a seed text which is inputted as a search condition for searching prestored object documents for a relevant document. Each object document is partitioned into a plurality of blocks, and character strings are extracted from each block. Similarity of each block to the seed text is calculated by comparing the character strings extracted from the block and the character strings extracted from the seed text. Whether or not each block is relevant to the seed text is judged by comparing the calculated similarity of the block with a preset threshold value. Based on the judgment, an “inclusion degree” of each object document (including the blocks) regarding the seed text is calculated, by which object documents relevant to the seed text are outputted.

### BACKGROUND OF THE INVENTION

The present invention relates to a document relevancy calculation method for calculating an index indicating relevancy or similarity between documents designated by the user, and a relevant document search method using the document relevancy calculation method.

With the prevalence of personal computers and the Internet of recent years, vast amounts of computerized documents exist and circulate today. In such circumstances, document search techniques for letting the user efficiently search large amounts of documents for a necessary document are being developed extensively. Among such techniques, “relevant document search” for finding documents similar to a text that is inputted as a search condition or search formula (hereafter, referred to as a “seed text”) are attracting increasing attention.

In a relevant document search technique disclosed in JP-A-9-160928, the degree of similarity (hereafter, simply referred to as “similarity” or “a similarity” with the plural form of “similarities”) between each sentence of the seed text and each sentence of an object text (text compared with the seed text) is calculated for all combinations of sentences between the seed text and the object text, and the total similarity between the seed text and the object text is obtained by adding up the calculated similarities. For example, when the seed text is composed of two sentences A and B and the object text is composed of three sentences C, D and E, the similarity of the object text to the seed text is calculated as [similarity between A and C]+[similarity between A and D]+[similarity between A and E]+[similarity between B and C]+[similarity between B and D]+[similarity between B and E]. By the method, a high similarity is outputted when the contents of the seed text have high similarity to the whole of the object text.

### SUMMARY OF THE INVENTION

However, in the conventional relevant document search technique, when similarities between certain sentences are extremely high, the total similarity between the seed text and the object text tends to be high even if similarities between other sentences are low. In other words, even if a high similarity is obtained for an object text, there are two possibilities: “overall similarity” (the whole object text is generally similar to the seed text) and “partial similarity” (part of the object text is highly similar to the seed text). Being incapable of distinguishing between the two types of similarity, the user or searcher can not carry out a search concerning the seed text efficiently according to the objective of the search. For example, when the user hopes to refer to object texts having the overall similarity to the seed text, the similarity calculated by the above conventional technique can not help the judgment.

It is therefore the object of the present invention to provide a relevant document search method by which an index for judging the similarity of documents is presented.

In order to achieve the above object, in a relevant document search method in accordance with an aspect of the present invention, character strings are extracted from a seed text which is inputted as a search condition for searching prestored object documents for a relevant document. Each object document is partitioned into a plurality of blocks, and character strings are extracted from each block. Similarity of each block to the seed text is calculated by comparing the character strings extracted from the block and the character strings extracted from the seed text. Whether or not each block is relevant to the seed text is judged by comparing the calculated similarity of the block with a preset threshold value. Based on the judgment, an “inclusion degree” of each object document (including the blocks) regarding the seed text is calculated.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing the overall composition of a relevant document search system in accordance with a first embodiment of the present invention;

FIG. 2 is a PAD diagram showing a process conducted by a search control program employed in the first embodiment;

FIG. 3 is a PAD diagram showing a process conducted by an inclusion degree calculation program employed in the first embodiment;

FIG. 4 is a schematic diagram showing a concrete process flow of the search control program of the first embodiment;

FIG. 5 is a schematic diagram showing an example of a search result list display outputted by the relevant document search system of the first embodiment;

FIG. 6 is a schematic diagram showing another example of the search result list display in the first embodiment;

FIG. 7 is a schematic diagram showing another example of the search result list display in the first embodiment, in which threshold values regarding similarity and inclusion degree are set;

FIG. 8 is a schematic diagram showing another example of the search result list display in the first embodiment, in which the similarity and the inclusion degree are displayed together with the full text of an object document;

FIG. 9 is a block diagram showing the overall composition of a relevant document search system in accordance with a second embodiment of the present invention;

FIG. 10 is a PAD diagram showing a process conducted by a search control program employed in the second embodiment;

FIG. 11 is a PAD diagram showing a process conducted by an inclusion degree calculation program employed in the second embodiment;

FIG. 12 is a schematic diagram showing a concrete flow of a relevant block judgment process which is executed by the search control program of the second embodiment;

FIG. 13 is a schematic diagram showing a concrete process flow of a block full-text search condition relevancy calculation program employed in the second embodiment;

FIG. 14 is a block diagram showing the overall composition of a relevant document search system in accordance with a third embodiment of the

FIG. 15 is a PAD diagram showing a process conducted by a registration control program employed in the third embodiment;

FIG. 16 is a PAD diagram showing a process conducted by an inclusion degree calculation program employed in the third embodiment; and

FIG. 17 is a schematic diagram showing a concrete process flow of the registration control program of the third embodiment.

### DESCRIPTION OF THE EMBODIMENTS

Referring now to the drawings, a description will be given in detail of preferred embodiments in accordance with the present invention.

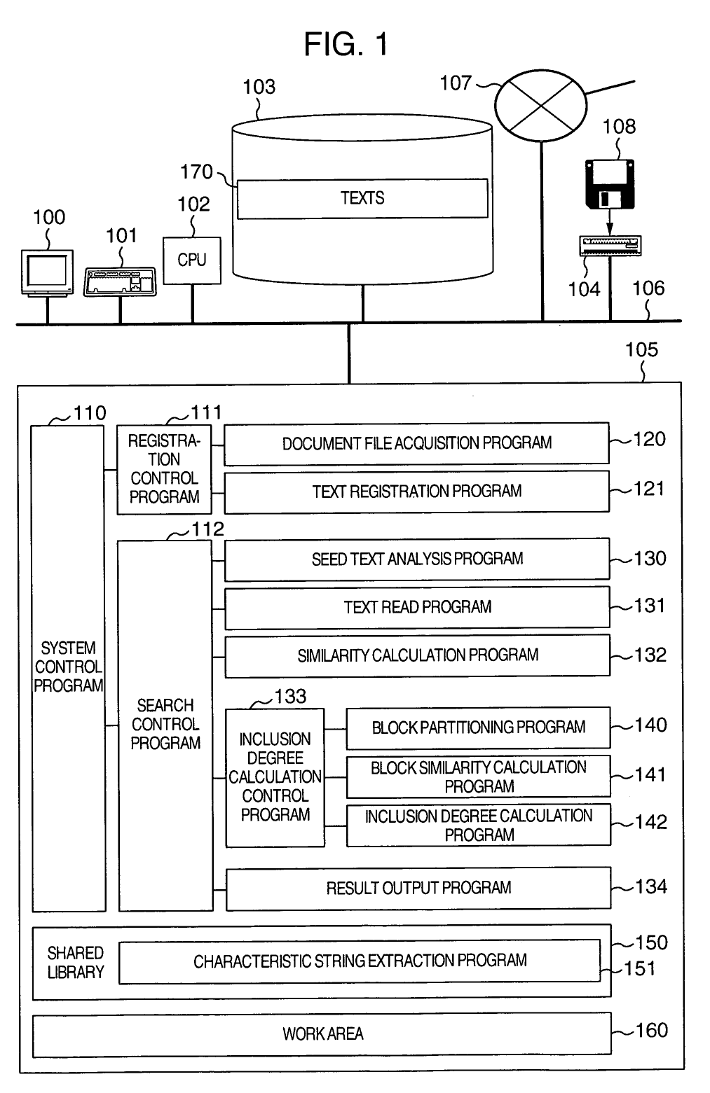

FIG. 1 is a block diagram showing the overall composition of a relevant document search system in accordance with a first embodiment of the present invention. The system includes a display 100, a keyboard 101, a CPU (Central Processing Unit) 102, a magnetic disk unit 103, an FDD (Flexible Disk Drive) 104, main memory 105, a bus 106 connecting the components, and a network 107 connecting the system with other devices.

The magnetic disk unit 103 is a type of secondary storage, in which texts 170 as the object texts are stored. Information stored in a flexible disk 108 is read out by the FDD 104 and loaded into the main memory 105 or the magnetic disk unit 103.

In the main memory 105, various programs and data such as a system control program 110, a registration control program 111, a document file acquisition program 120, a text registration program 121, a seed text analysis program 130, a text read program 131, a similarity calculation program 132, an inclusion degree calculation control program 133, a block partitioning program 140, a block similarity calculation program 141, an inclusion degree calculation program 142, a result output program 134 and a shared library 150 are stored and a work area 160 is reserved. The shared library 150 includes a characteristic string extraction program 151.

The system control program 110 includes the registration control program 111 and the search control program 112. The registration control program 111 includes the document file acquisition program 120 and the text registration program 121. The search control program 112 includes the seed text analysis program 130, the text read program 131, the similarity calculation program 132, the inclusion degree calculation control program 133 and the result output program 134, while having the function of calling the characteristic string extraction program 151 of the shared library 150. The inclusion degree calculation control program 133 includes the block partitioning program 140, the block similarity calculation program 141 and the inclusion degree calculation program 142, while having the function of calling the characteristic string extraction program 151 of the shared library 150.

The registration control program 111 and the search control program 112 are activated by the system control program 110 according to key input by the user from the keyboard 101. The document file acquisition program 120 and the text registration program 121 are controlled by the registration control program 111 controls. The seed text analysis program 130, the characteristic string extraction program 151, the text read program 131, the similarity calculation program 132, the inclusion degree calculation control program 133 and the result output program 134 are controlled by the search control program 112.

Incidentally, while the registration control program 111 and the search control program 112 in this embodiment are activated by command input through the keyboard 101, they may also be activated by commands from other input devices or by particular events.

The above programs may be stored in the magnetic disk unit 103 or a record medium (flexible disk 108, unshown MO, CD-ROM, DVD, etc.), loaded into the main memory 105 through a disk drive/unit, and executed by the CPU 102. The programs to be executed by the CPU 102 may also be load into the main memory 105 through the network 107.

While the texts 170 are assumed to be stored in the magnetic disk unit 103 in this embodiment, they may also be stored in a record medium (flexible disk 108, MO, CD-RW, DVD-RW, etc.) and loaded into the main memory 105 for use. Or, the texts 170 can also be stored in a record medium of another system (unshown in FIG. 1) via the network 107 or in a record medium directly connected to the network 107.

Next, a process conducted by the system control program 110 will be explained. The system control program 110 first analyzes a command inputted through the keyboard 101. If the command is recognized by the analysis as a registration execution command, the system control program 110 activates the registration control program 111 and thereby carries out a document registration process. If the command is recognized as a search execution command, the system control program 110 activates the search control program 112 and thereby carries out a document search process for finding documents having contents relevant to a “seed text” (words, sentence, text or document inputted as a search condition).

Next, a process conducted by the registration control program 111 activated by the system control program 110 will be explained. The registration control program 111 first activates the document file acquisition program 120, by which a document file stored in the flexible disk 108 is read out via the FDD 104. Subsequently, the text registration program 121 is activated, by which texts are extracted from the document file read out by the document file acquisition program 120 and the extracted texts are stored in the magnetic disk unit 103 as the texts 170.

While the document file to be read out by the document file acquisition program 120 was assumed to be stored in the flexible disk 108 in the above explanation, the document file can also be read out from other record media (unshown MO, CD-ROM, DVD, etc.), or from a record medium of another system (unshown in FIG. 1) via the network 107. The type or format of the document file read by the document file acquisition program 120 is not particularly limited (text file, format of application software, etc.) as long as texts can be extracted from the document file.

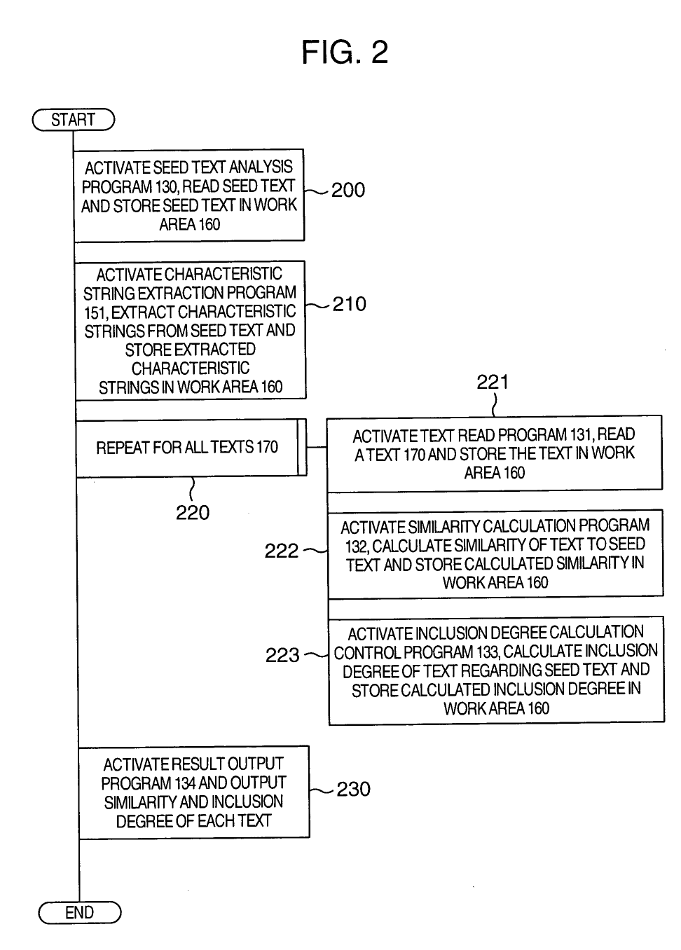

Next, a process conducted by the search control program 112 activated by the system control program 110 will be explained referring to FIG. 2. The search control program 112 first activates the seed text analysis program 130, by which the seed text designated as the search condition is read and stored in the work area 160 (step 200). Subsequently, the characteristic string extraction program 151 is activated and character strings having independent meanings (hereafter, referred to as “characteristic strings”) are extracted from the seed text stored in the work area 160 by the seed text analysis program 130, and the extracted characteristic strings are stored in the work area 160 (step 210).

The following steps 221-223 are repeated for all the texts 170 (step 220). First, the text read program 131 is activated and thereby one of the texts 170 stored in the magnetic disk unit 103 is read out (step 221). Subsequently, the similarity calculation program 132 is activated, by which similarity of the text (read by the text read program 131) to the seed text is calculated by use of a general relevant document search technique and the calculated similarity is stored in the work area 160 (step 222). Subsequently, the inclusion degree calculation control program 133 is activated, by which the ratio of relevant contents (contents of the text relevant to the seed text) to the whole text (the degree of inclusion of relevant contents, hereafter referred to as “inclusion degree”) is calculated, and the calculated inclusion degree is stored in the work area 160 (step 223).

Finally, the result output program 134 is activated and thereby the similarly obtained by the similarity calculation program 132 and the inclusion degree obtained by the inclusion degree calculation control program 133 are outputted for each text (step 230).

Incidentally, the “characteristic strings” the characteristic string extraction program 151 extracts may be character strings that are separated by separators (space etc.) existing in the text or by interfaces between character types (alphabetical letters, kanji characters, hiragana letters, katakana letters, etc.), or may be words extracted by morphological analysis, character strings extracted as n-grams, or character strings extracted by other methods.

The similarity calculation process of the step 222 can be conducted by the aforementioned conventional similarity calculation method, by a similarity calculation method using cosine similarity in the vector space method, etc.

While the steps 221-223 ware repeated for all the texts 170 in the above explanation, it is also possible to carry out the steps 221-223 for part of the texts 170.

While the similarity and the inclusion degree were calculated for the whole text read by the text read program 131, it is also possible to execute the calculation according to the present invention for part of the text.

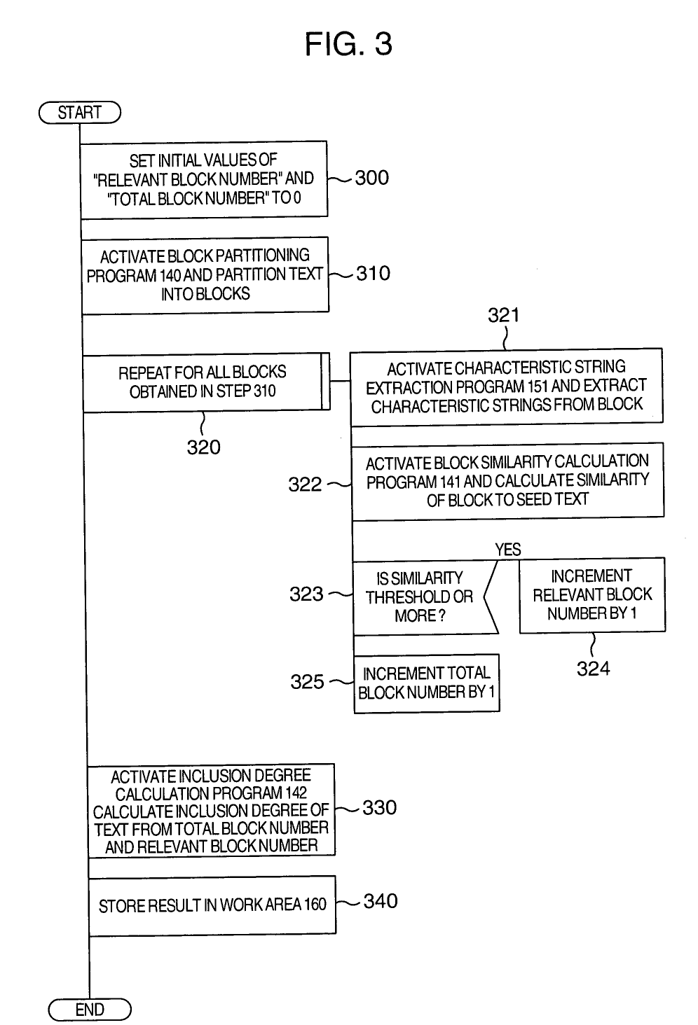

Next, a process conducted by the inclusion degree calculation control program 133 activated by the search control program 112 (details of the step 223 of FIG. 2) will be explained referring to FIG. 3.

First, initial values of “relevant block number” (the number of blocks relevant to the seed text) and “total block number” (the total number of blocks included in the text) are both set to 0 (step 300). Subsequently, the block partitioning program 140 is activated and thereby the text read out by the text read program 131 is partitioned into parts such as sentences, paragraphs or chapters (hereafter, simply referred to as “blocks”) (step 310).

The following steps 321-325 are repeated for all the blocks obtained in the step 310 (step 320). First, the characteristic string extraction program 151 is activated and thereby characteristic strings are extracted from each block obtained in the step 310 (step 321). Subsequently, the block similarity calculation program 141 is activated, by which similarity of each block to the seed text is calculated by the following equation (1) based on the characteristic strings of the seed text (extracted in the step 210 of FIG. 2) and the characteristic strings of the block (extracted in the step 321 of FIG. 3) (step 322).

{similarity}={the number of characteristic strings common to the seed text and the block}/{the number of characteristic strings in the seed text} (1)

Subsequently, the similarity of the block calculated in the step 322 is compared with a reference value which is used for judging the relevancy to the seed text (hereafter, referred to as “seed text relevancy threshold”) (step 323). If the similarity of the block is the seed text relevancy threshold or more (YES in the step 323), the block is judged to be a block relevant to the seed text (hereafter, referred to as “relevant block”), and the relevant block number is incremented by 1 (step 324) while incrementing the total block number by 1 (step 325). If the similarity of the block is less than the seed text relevancy threshold (NO in the step 323), only the total block number is incremented by 1 (step 325) without incrementing the relevant block number.

When the steps 321-325 are finished for all the blocks obtained from the text in the step 310, the inclusion degree calculation program 142 is activated, by which the inclusion degree of the text regarding the seed text is calculated by the following equation (2) based on the relevant block number and the total block number counted in the steps 324 and 325 (step 330).

$$\begin{matrix}\text{\{inclusion degree\}} = \text{\{relevant block number\}} / \\ \text{\{total block number\}}\end{matrix} \qquad ( 2 )$$

Finally, the inclusion degree of the text regarding the seed text calculated in the step 330 is stored in the work area 160 (step 340).

Incidentally, while the block similarity was calculated in the above step 322 employing the equation (1), other types of calculations such as cosine similarity in the vector space method can also be employed.

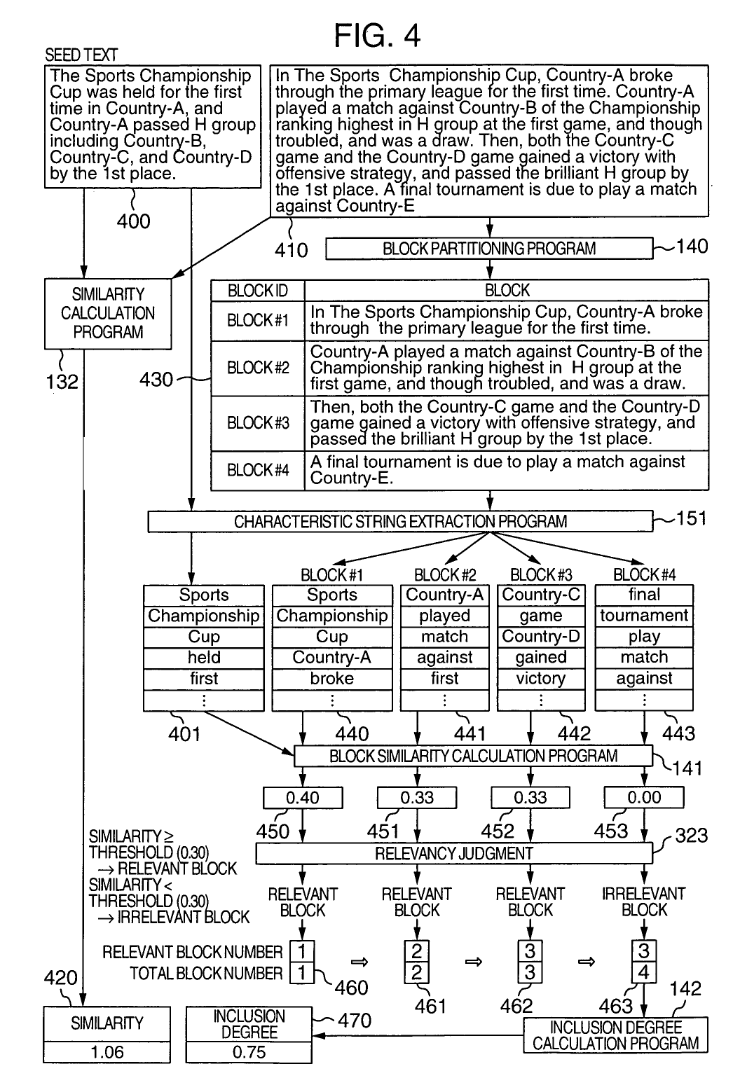

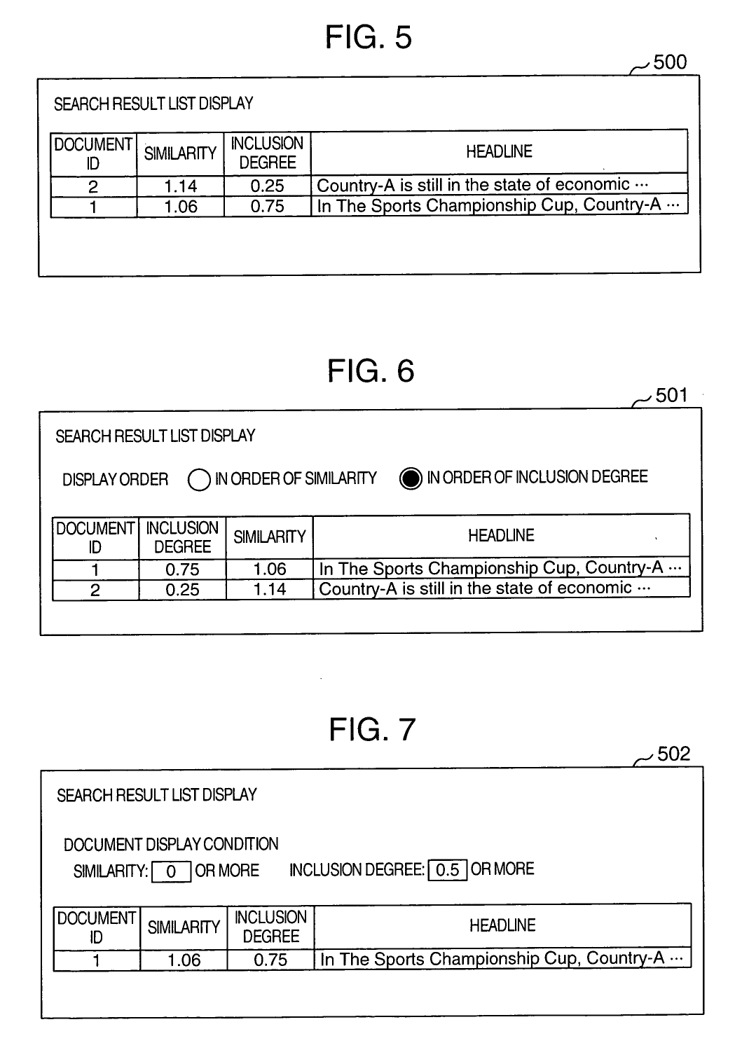

In the following, the flow of the document search process conducted by the relevant document search system of this embodiment will be explained in detail with reference to FIGS. 4 and 5.

FIG. 4 shows a case where a document #1: “In The Sports Championship Cup, Country-A broke through the primary league for the first time. Country-A played a match against Country-B of the Championship ranking highest in H group at the first game, and though troubled, and was a draw. Then, both the Country-C game and the Country-D game gained a victory with offensive strategy, and passed the brilliant H group by the 1st place. A final tournament is due to play a match against Country-E.” and a document #2: “Country-A is still in the state of economic depression. If there is bright news that induces an economic big effect, can Country-A escape from economic depression? The Sports Championship Cup was held for the first time in Country-A, and Country-A passed H group including Country-B, Country-C, and Country-D by the 1st place on the other day. However, it was not able to become an explosive to economic recovery and an economic big effect could not be acquired.” (unshown in FIG. 4) have been stored in the magnetic disk unit 103 of the relevant document search system and a text: “The Sports Championship Cup held for the first time in Country-A, and Country-A passed H group including Country-B, Country-C, and Country-D by the 1st place” has been inputted as the seed text. At the stage of FIG. 4, the above seed text inputted as the search condition has been read by the seed text analysis program 130 as a seed text 400, and the document #1 has been read by the text read program 131 as a text 410.

First, the similarity calculation program 132 is executed and thereby the similarity of the text 410 (read out by the text read program 131) to the seed text 400 (read by the seed text analysis program 130) is calculated (step 222 of FIG. 2). In this embodiment, the similarity is calculated employing the aforementioned conventional similarity calculation method, and similarity “1.06” obtained as a similarity calculation result 420 is stored in the work area 160. In the calculation, the weight is set to 1 for every sentence included in the seed text.

Subsequently, the block partitioning program 140 is executed and thereby the text 410 is partitioned into blocks (step 310 of FIG. 3). In the example of FIG. 4, the partitioning into blocks has been done using periods “.” as separators and thereby a block partitioning result 430 has been obtained. The block partitioning result 430 of FIG. 4 is composed of a block #1: “In The Sports Championship Cup, Country-A broke through the primary league for the first time.”, a block #2: “Country-A played a match against Country-B of the Championship ranking highest in H group at the first game, and though troubled, and was a draw.”, a block #3: “Then, both the Country-C game and the Country-D game gained a victory with offensive strategy, and passed the brilliant H group by the 1st place.”, and a block #4: “A final tournament is due to play a match against Country-E.”. The blocks #1-#4 have been stored in the work area 160.

Meanwhile, the characteristic string extraction program 151 is executed, by which character strings “Sports”, “Championship”, “Cup”, “held”, “first”, “time”, “Country-A”, “passed”, “group”, “including”, “Country-B”, “Country-C”, “Country-D”, “1st”, and “place” are extracted as characteristic strings 401 from the seed text 400 (step 210 of FIG. 2). From the block #1 of the block partitioning result 430, character strings “Sports”, “Championship”, “Cup”, “Country-A”, “broke”, “through”, “primary”, “league”, “first”, and “time” are extracted as characteristic strings 440 (step 321 of FIG. 3). Similarly, character strings “Country-A”, “played”, “match”, “against”, “first”, “game”, “Country-B”, “Championship”, “ranking”, “highest”, “group”, “though”, “troubled”, and “draw” are extracted as characteristic strings 441 from the block #2, character strings “Country-C”, “game”, “Country-D”, “gained”, “victory”, “offensive”, “strategy”, “passed”, “brilliant”, “group”, “1st”, and “place” are extracted as characteristic strings 442 from the block #3, and character strings “final”, “tournament”, “play”, “match”, “against”, and “Country-E” are extracted as characteristic strings 443 from the block #4.

Subsequently, the block similarity calculation program 141 is executed, by which the similarity of the block #1 to the seed text is calculated based on the characteristic strings 440 of the block #1 and the characteristic strings 401 of the seed text (step 322 of FIG. 3). In the example of FIG. 4, there are six common characteristic strings “Sports”, “Championship”, “Cup”, “Country-A”, “first”, and “time” between the characteristic strings 401 of the seed text and the characteristic strings 440 of the block #1. Since the total number of characteristic strings included in the seed text is 15, similarity “0.40”is obtained from the aforementioned equation (1) as a similarity calculation result 450 for the block #1.

Also for the blocks #2-#4, similarities “0.33”, “0.33”, and “0.00” as similarity calculation results 451-453 are obtained in the same way by the block similarity calculation program 141 based on the characteristic strings 441-443 of the blocks #2-#4 and the characteristic strings 401 of the seed text.

Subsequently, whether or not the similarity calculation result 450 for the block #1 is the preset seed text relevancy threshold or more is judged (step 323 of FIG. 3). If YES, the block #1 is judged to be a relevant block to the seed text and the relevant block number is incremented by 1 (step 324 of FIG. 3). In the example of FIG. 4, the seed text relevancy threshold has been set to “0.30”, and thus the block #1 is judged to be a relevant block and both the relevant block number and the total block number are incremented by 1 (steps 324 and 325 of FIG. 3).

Also for the blocks #2-#4, the steps 323 of FIG. 3 is executed, by which the blocks #2 and #3 are judged to be relevant blocks and the block #4 is judged to be an irrelevant block. Both the relevant block number and the total block number are incremented by 1 for each of the relevant blocks #2 and #3. For the irrelevant block #4, only the total block number is incremented by 1 without incrementing the relevant block number.

When the relevant block judgment process of the step 323 is finished for each block #1-#4, each relevant/total block number calculation result 460-463 is obtained successively, by which a relevant block number “3” and a total block number “4” are obtained for the block #1 from the final relevant/total block number calculation result 463.

Subsequently, the inclusion degree calculation program 142 is executed and thereby the inclusion degree of the document #1 regarding the seed text is calculated from the aforementioned equation (2) based on the relevant/total block number calculation result 463 (step 330 of FIG. 3). Consequently, an inclusion degree “0.75” is obtained and stored in the work area 160 as an inclusion degree calculation result 470 (step 340 of FIG. 3).

Also for the document #2, the similarity and the inclusion degree are calculated in the same way and similarity “1.14” and an inclusion degree “0.25” are obtained.

After the similarity and the inclusion degree are obtained for both the documents #1 and #2 stored in the magnetic disk unit 103, the result output program 134 (unshown in FIG. 4) is executed and thereby the similarity calculation results and the inclusion degree calculation results (for the documents #1 and #2) stored in the work area 160 are outputted in the form of a search result list display 500 as shown in FIG. 5. In the example of FIG. 5, a document ID, similarity, inclusion degree, and headline are outputted for each of the documents #1 and #2, in which the similarity and inclusion degree of the document #1 are “1.06” and “0.75” and those of the document #2 are “1.14” and “0.25”.

By comparison between the similarities “1.06” (document #1) and “1.14” (document #2) only, the document #2 seems to be more effective and relevant to the seed text; however, the document #1, having the inclusion degree “0.75” higher than “0.25” of the document #2, can be regarded to have higher overall relevancy (overall similarity) to the seed text than the document #2. Therefore, more efficient document search can be realized by giving higher reference priority to the document #1 based on the outputted inclusion degrees.

Incidentally, while the document ID, similarity, inclusion degree, and headline were outputted as the search result list display 500 in the example of FIG. 5, property information such as the date of registration may also be registered when each document is registered, and such property information may also be displayed in the search result list display 500 by the result output program 134. While both the similarities and the inclusion degrees were displayed in the search result list display 500, it is also possible to display the inclusion degrees only.

Further, while the results for documents were outputted in descending order regarding the similarity in the example of FIG. 5, the results may also be outputted in descending order regarding the inclusion degree. The way of displaying the results may be selected from display options as shown in FIG. 6. In the GUI shown in FIG. 6, display options concerning the descending display order: “in order of similarity” and “in order of inclusion degree” are shown. In the example of FIG. 6, “in order of inclusion degree” has been selected by the searcher and the documents #1 and #2 are displayed in descending order of the inclusion degree.

While the results for all the texts 170 stored in the magnetic disk unit 103 were displayed in the examples shown in FIGS. 5 and 6, threshold values regarding the similarity and the inclusion degree may previously be set by the searcher or system administrator, and the object of result display may be limited to texts (documents) satisfying the threshold values as shown in FIG. 7. In the GUI shown in FIG. 7, a threshold “0.00” regarding the similarity and a threshold “0.50” regarding the inclusion degree have been set, by which only the result for the document #1 satisfying the thresholds is displayed.

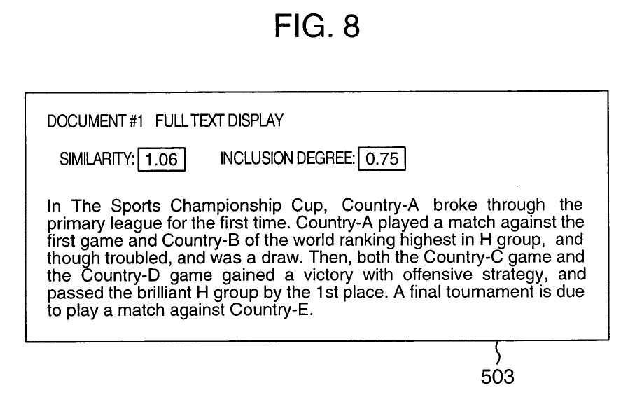

While the similarity and the inclusion degree of each text (document) were displayed in the search result list display in the examples of FIGS. 5, 6 and 7, it is also possible to display the similarity and/or the inclusion degree together with the full text of a designated document as shown in FIG. 8. In the example of FIG. 8, the full text of the document #1 are displayed together with its similarity and inclusion degree. As another example, it is also possible to display the full text, similarity and inclusion degree (as in FIG. 8) for documents satisfying the threshold values regarding the similarity and inclusion degree while displaying the document ID, similarity, inclusion degree, and headline in a list display (as in FIG. 5 or FIG. 6) for documents that do not satisfy the threshold values.

In the aforementioned method for calculating the similarity of an object text to the seed text, the similarity of the object text may also be calculated by adding up the similarity calculation results 450-453 obtained by the block similarity calculation program 141 in the step 322 of FIG. 3, without executing the similarity calculation program 132 (step 222 of FIG. 2).

While the similarity calculation program 132 (step 222 of FIG. 2) and the inclusion degree calculation control program 133 (step 223 of FIG. 2) were executed for all the texts 170 in the above embodiment, it is possible to execute the inclusion degree calculation control program 133 only for selected texts having similarity (obtained by the similarity calculation program 132) satisfying the threshold value regarding the similarity. On the other hand, it is also possible to execute the similarity calculation program 132 only for selected texts having an inclusion degree (obtained by the inclusion degree calculation control program 133) satisfying the threshold value regarding the inclusion degree. By such methods, the number of texts as the objects of the similarity calculation or inclusion degree calculation can be reduced and the speed of document search can be increased.

While the system of the above embodiment has been explained as a document search system for judging the relevancy of the stored documents to the search condition, the inclusion degree calculation control program 133 in accordance with the present invention can also be used for replacing a relevancy calculation program of a relevant document search/delivery system disclosed in JP-A-2000-339346.

Therefore, the inclusion degree in accordance with the present invention is applicable not only to document search systems (for judging the relevancy of stored documents to a search condition) but also to document delivery systems for judging the relevancy of an object document to a delivery condition.

As explained above, by the relevant document search system in accordance with the first embodiment of the present invention, it becomes possible to judge whether the object document (object text) has the “overall similarity” to the seed text (the whole object text is similar to the contents of the seed text) or the “partial similarity” to the seed text (part of the object text is similar to the contents of the seed text), by which relevant documents can be searched for with high efficiency according to the objective of the search.

In the following, a second embodiment in accordance with the present invention will be explained in detail. In the second embodiment, a seed text and a full-text search condition are designated as search conditions, and the inclusion degree is calculated taking both search conditions into consideration.

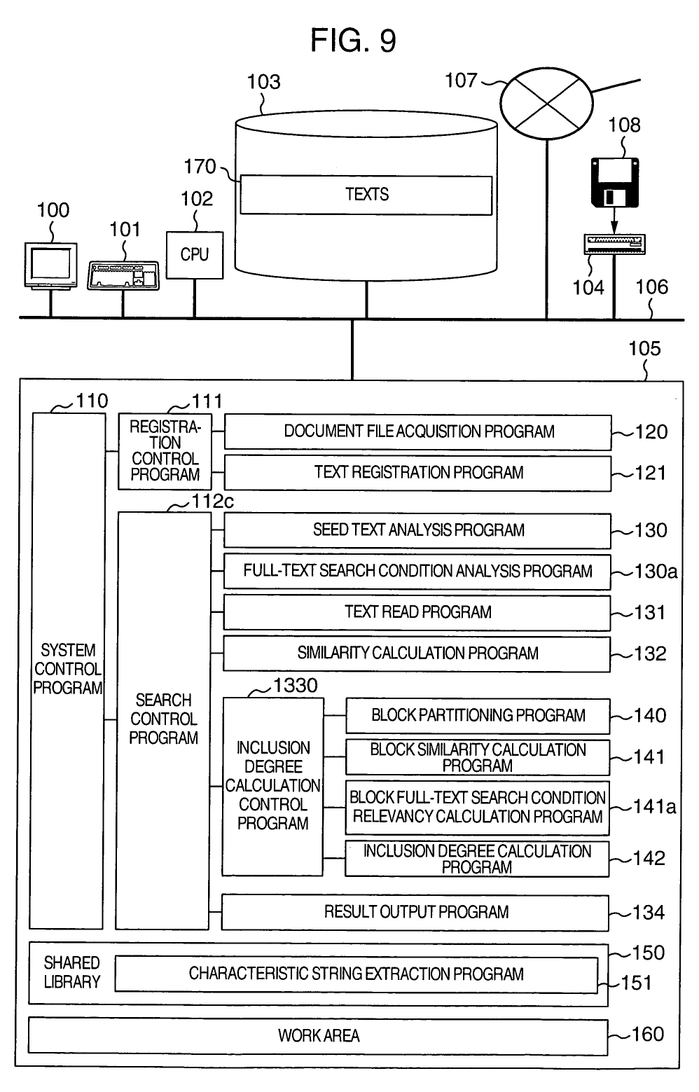

The document search system of the second embodiment has almost the same composition as the system of the first embodiment shown in FIG. 1 except for the composition of the search control program 112 and the inclusion degree calculation control program 133. As shown in FIG. 9, a search control program 112c of the system of the second embodiment further includes a full-text search condition analysis program 130a. The search control program 112c includes an inclusion degree calculation control program 1330 instead of the inclusion degree calculation control program 133 of the first embodiment. The inclusion degree calculation control program 1330 includes a block full-text search condition relevancy calculation program 141a in addition to the components of the inclusion degree calculation control program 133 of FIG. 1.

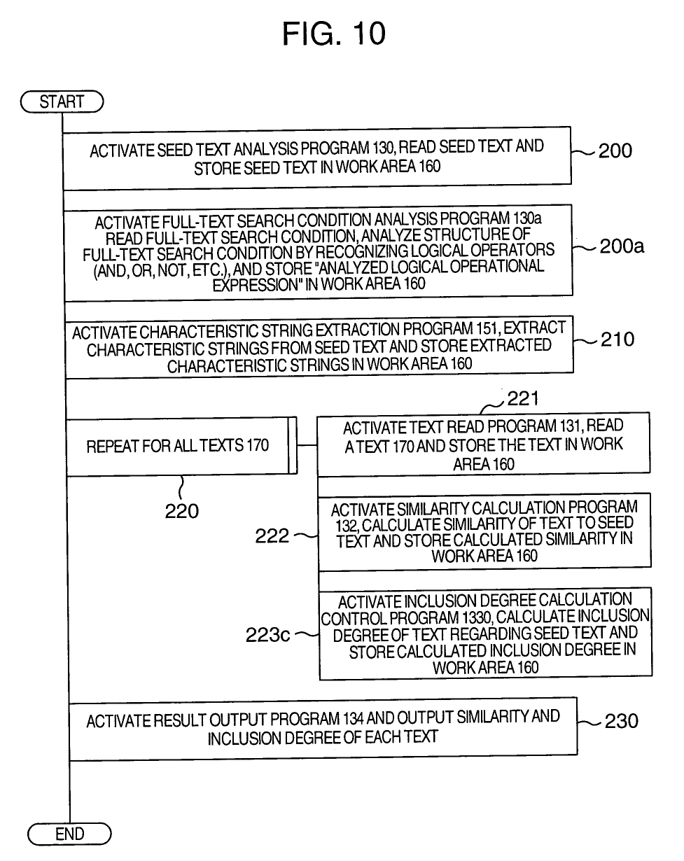

In the following, a process conducted by the search control program 112c which is different from the first embodiment will be explained referring to FIG. 10. The difference from the first embodiment (FIG. 2) is: the execution of the full-text search condition analysis program 130a (step 200a) after the execution of the seed text analysis program 130; and the execution of the inclusion degree calculation control program 1330 (step 223a) after the execution of the similarity calculation program 132.

First, the search control program 112c activates the seed text analysis program 130, by which a seed text designated as a search condition is read and stored in the work area 160 (step 200). Subsequently, the search control program 112c activates the full-text search condition analysis program 130a. The full-text search condition analysis program 130a reads a full-text search condition designated as another search condition, analyzes the structure of the full-text search condition by recognizing logical operators (AND, OR, NOT, etc.) included in the full-text search condition, and stores a logical operational expression being expressed in the conjunctive normal form (hereafter, referred to as “analyzed logical operational expression”) in the work area 160 (step 200a). Subsequently, the search control program 112c activates the characteristic string extraction program 151, by which characteristic strings are extracted from the seed text which has been stored in the work area 160 by the seed text analysis program 130, and the extracted characteristic strings are stored in the work area 160 (step 210).

Subsequently, the following steps 221-223c are repeated for all the texts 170 (step 220). First, the text read program 131 is activated and thereby one of the texts 170 stored in the magnetic disk unit 103 is read out (step 221). Subsequently, the similarity calculation program 132 is activated, by which the similarity of the text (read by the text read program 131) to the seed text is calculated and the calculated similarity is stored in the work area 160 (step 222). Subsequently, the inclusion degree calculation control program 1330 is activated, by which the inclusion degree of the text (read by the text read program 131) regarding the search conditions (seed text, full-text search condition) is calculated, and the calculated inclusion degree is stored in the work area 160 (step 223c).

Finally, the result output program 134 is activated and thereby the similarity obtained by the similarity calculation program 132 and the inclusion degree obtained by the inclusion degree calculation control program 1330 are outputted for each text (step 230).

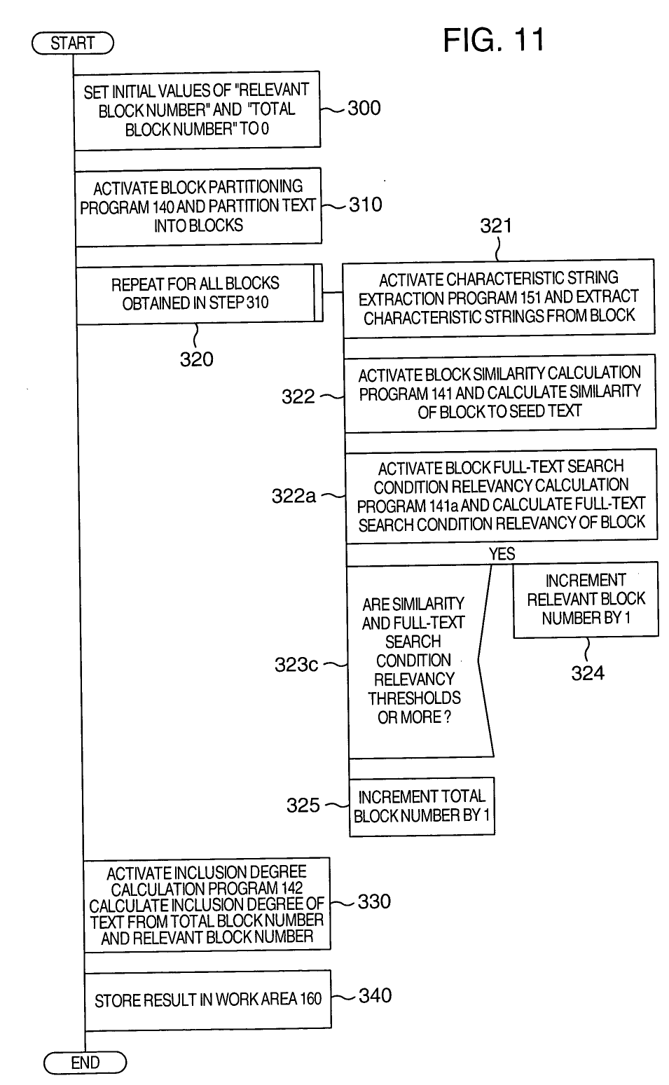

Next, a process conducted by the inclusion degree calculation control program 1330 (details of the step 223c of FIG. 10) will be explained referring to FIG. 11. The difference from the first embodiment (FIG. 3) is: the execution of the block full-text search condition relevancy calculation program 141a (step 322a) after the execution of the block similarity calculation program 141; and a relevancy judgment step 323c which is executed differently from the relevancy judgment step 323 of FIG. 3. In the relevancy judgment step 323c of FIG. 11, not only the seed text relevancy threshold (which was used in the relevancy judgment step 323 of FIG. 3) but also a threshold value regarding “full-text search condition relevancy” calculated by the block full-text search condition relevancy calculation program 141a (hereafter, referred to as “full-text search condition relevancy threshold”) is used for the judgment on the relevant blocks.

First, initial values of the relevant block number and the total block number are both set to 0 (step 300). Subsequently, the block partitioning program 140 is activated and thereby the text read out in the step 221 of FIG. 10 is partitioned into blocks (step 310).

Subsequently, the following steps 321-325 are repeated for all the blocks obtained in the step 310 (step 320). First, the characteristic string extraction program 151 is activated and thereby characteristic strings are extracted from each block (step 321). Subsequently, the block similarity calculation program 141 is activated, by which the similarity of each block to the seed text is calculated by the aforementioned equation (1) based on the characteristic strings of the seed text (extracted in the step 210 of FIG. 10) and the characteristic strings of the block (extracted in the step 321 of FIG. 11) (step 322).

Subsequently, the block full-text search condition relevancy calculation program 141a is activated, by which relevancy of the block to the full-text search condition (hereafter, referred to as “full-text search condition relevancy”) is calculated based on the analyzed logical operational expression obtained by the full-text search condition analysis program 130a (step 322a).

Subsequently, the full-text search condition relevancy of the block calculated in the step 322a is compared with the full-text search condition relevancy threshold while comparing the similarity of the block calculated by the block similarity calculation program 141 with the seed text relevancy threshold (step 323c). If the similarity of the block is the seed text relevancy threshold or more and the full-text search condition relevancy of the block is the full-text search condition relevancy threshold or more (YES in the step 323c), the block is judged to be a block relevant to the search conditions (relevant block), and the relevant block number is incremented by 1 (step 324) while incrementing the total block number by 1 (step 325). If the similarity or the full-text search condition relevancy of the block does not satisfy the threshold (NO in the step 323c), only the total block number is incremented by 1 (step 325) without incrementing the relevant block number.

When the steps 321-325 are finished for all the blocks obtained from the text in the step 310, the inclusion degree calculation program 142 is activated, by which the inclusion degree of the text regarding the search conditions (seed text, full-text search condition) is calculated by the equation (2) based on the relevant block number and the total block number counted in the steps 324 and 325 (step 330).

$$\begin{matrix}\text{\{inclusion degree\}} = \text{\{relevant block number\}} / \\ \text{\{total block number\}}\end{matrix} \qquad ( 2 )$$

Finally, the inclusion degree of the text regarding the search conditions (seed text, full-text search condition) calculated in the step 330 is stored in the work area 160 (step 340).

Next, a process conducted by the block full-text search condition relevancy calculation program 141a activated by the inclusion degree calculation control program 1330 (details of the step 322a of FIG. 11) will be explained. First, from the analyzed logical operational expression in the conjunctive normal form which has been stored in the work area 160 by the full-text search condition analysis program 130a, min terms (sub logical operational expressions) are extracted. The min terms mean words and logical operational expressions that are obtained by partitioning the analyzed logical operational expression using its AND operators as interfaces. Subsequently, whether or not the characteristic strings of the block to be processed (extracted by the characteristic string extraction program 151) satisfy the condition of each min term is judged.

By the above judgment, the number of min terms satisfied by (the characteristic strings of) the block (hereafter, referred to as “relevant min term number”) and the total number of min terms included in the analyzed logical operational expression (hereafter, referred to as “total min term number”) are counted, and the full-text search condition relevancy of the block to the full-text search condition is calculated by the following equation (3):

$$\begin{matrix}\text{\{full-text search condition relevancy\}} = \text{\{relevant min term number\}} / \\ \text{\{total min term number\}}\end{matrix} \qquad ( 3 )$$

Incidentally, while the above calculation of the full-text search condition relevancy by the block full-text search condition relevancy calculation program 141a (step 322a) was conducted using the equation (3) (that is, by dividing the number of min terms satisfied by the characteristic strings of the block by the total number of min terms included in the designated full-text search condition), the calculation may also be done using other methods such as those disclosed in JP-A-11-154164, JP-A-2001-84255, etc.

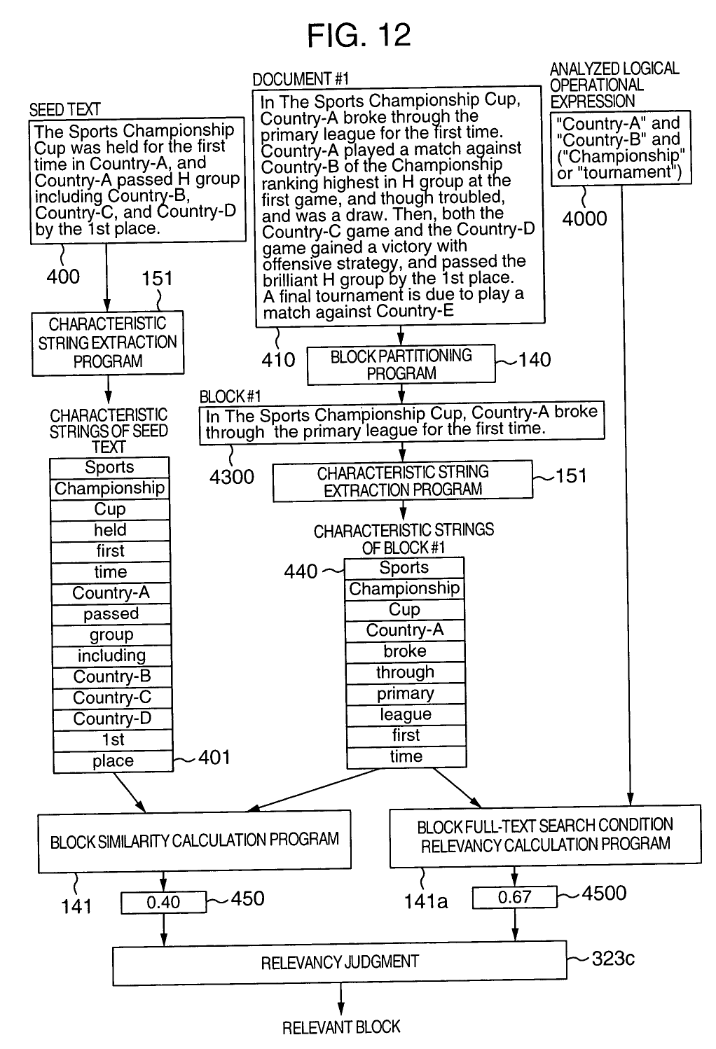

In the following, the concrete flow of the block relevancy judgment process conducted in the document search process of the second embodiment will be explained in detail referring to FIG. 12.

FIG. 12 shows a case where a document #1: “In The Sports Championship Cup, Country-A broke through the primary league for the first time. Country-A played a match against Country-B of the Championship ranking highest in H group at the first game, and though troubled, and was a draw. Then, both the Country-C game and the Country-D game gained a victory with offensive strategy, and passed the brilliant H group by the 1st place. A final tournament is due to play a match against Country-E.” has been stored in the magnetic disk unit 103 of the document search system and a seed text: “The Sports Championship Cup held for the first time in Country-A, and Country-A passed H group including Country-B, Country-C, and Country-D by the 1st place” and a full-text search condition: ““country-A” and “country-B” and (“Championship” or “tournament”)” have been inputted as the search conditions. At the stage of FIG. 12, the seed text inputted as a search condition has been read by the seed text analysis program 130 as a seed text 400, the full-text search condition inputted as another search condition has been read by the full-text search condition analysis program 130a as an analyzed logical operational expression 4000, and the document #1 has been read by the text read program 131 as a text 410.

First, the characteristic string extraction program 151 is executed, by which character strings “Sports”, “Championship”, “Cup”, “held”, “first”, “time”, “Country-A”, “passed”, “group”, “including”, “Country-B”, “Country-C”, “Country-D”, “1st”, and “place” are extracted as characteristic strings 401 from the seed text 400 (step 210 of FIG. 10). Subsequently, the block partitioning program 140 is executed and thereby the text 410 is partitioned into blocks (step 310 of FIG. 11). In the example of FIG. 12, the partitioning into blocks has been done using periods “.” as separators and thereby a block #1: “In The Sports Championship Cup, Country-A broke through the primary league for the first time.” has been obtained as a block partitioning result 4300.

Subsequently, the characteristic string extraction program 151 is executed and thereby character strings “Sports”, “Championship”, “Cup”, “Country-A”, “broke”, “through”, “primary”, “league”, “first”, and “time” are extracted from the block #1 of the document #1 as characteristic strings 440 (step 321 of FIG. 11). Subsequently, the block similarity calculation program 141 is executed, by which the similarity of the block #1 to the seed text is calculated based on the characteristic strings 440 of the block #1 and the characteristic strings 401 of the seed text (step 322 of FIG. 11). In the example of FIG. 12, there are six common characteristic strings “Sports”, “Championship”, “Cup”, “Country-A”, “first”, and “time” between the characteristic strings 401 of the seed text and the characteristic strings 440 of the block #1. Since the total number of characteristic strings included in the seed text is 15, similarity “0.40” is obtained from the aforementioned equation (1) as a similarity calculation result 450 for the block #1.

Subsequently, the block full-text search condition relevancy calculation program 141a is executed and thereby the full-text search condition relevancy of the block #1 is calculated (step 322a of FIG. 11). In the example of FIG. 12, the min terms of the analyzed logical operational expression 4000 (“country-A” and “country-B” and (“Championship” or “tournament”)) are “country-A”, “country-B”, and (“Championship” or “tournament”), while the characteristic strings 440 of the block #1 includes “Country-A” and “Championship”. Since two of the three min terms of the analyzed logical operational expression 4000 are satisfied by the characteristic strings 440 of the block #1, “0.67” is obtained as a full-text search condition relevancy calculation result 4500 for the block #1.

Subsequently, whether or not the similarity of the block #1 (similarity calculation result 450) is the seed text relevancy threshold or more and the full-text search condition relevancy of the block #1 (full-text search condition relevancy calculation result 4500) is the full-text search condition relevancy threshold or more is judged (step 323c of FIG. 11). If both thresholds are satisfied (YES in the step 323c), the block #1 is judged to be a relevant block regarding the search conditions (seed text, full-text search condition). In the example of FIG. 12, both the seed text relevancy threshold and the full-text search condition relevancy threshold have been set to “0.30”, and thus the block #1 (similarity: 0.40, full-text search condition relevancy: 0.67) is judged to be a relevant block and both the relevant block number and the total block number are incremented by 1 (steps 324 and 325 of FIG. 11).

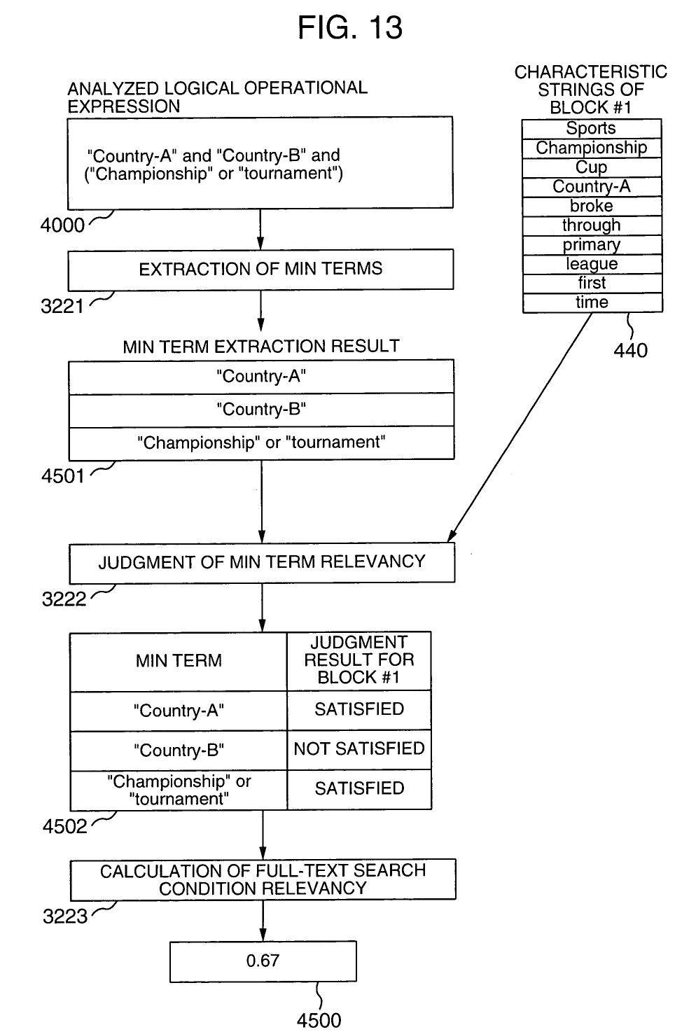

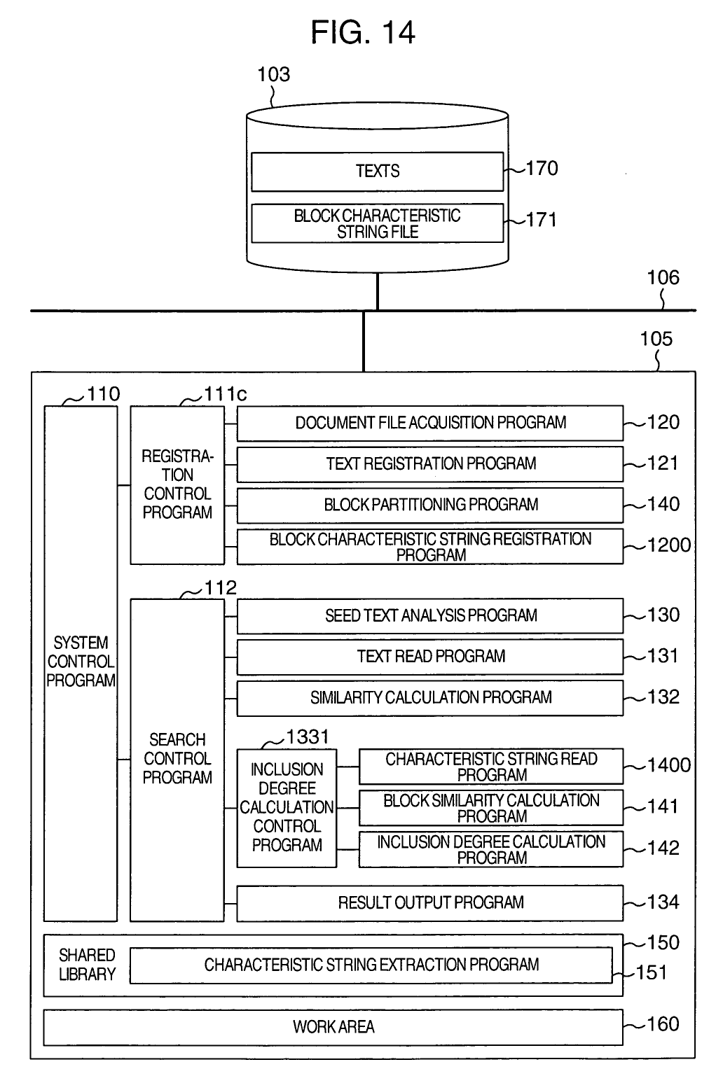

Next, the details of the block full-text search condition relevancy calculation process (step 322a of FIG. 11) conducted by the block full-text search condition relevancy calculation program 141a will be explained referring to FIG. 13.

FIG. 13 shows a process flow for calculating the full-text search condition relevancy of the block #1 based on the analyzed logical operational expression 4000 (“country-A” and “country-B” and (“Championship” or “tournament”)) read by the full-text search condition analysis program 130a and the characteristic strings 440 of the block #1 shown in FIG. 12.

First, min terms 4501 are extracted from the analyzed logical operational expression 4000 (step 3221). The analyzed logical operational expression which has been read in the conjunctive normal form is partitioned using its AND operators as interfaces and thereby the min terms (words and logical operational expressions) are extracted. In the example of FIG. 13, three min terms 4501: “country-A”, “country-B”, and (“Championship” or “tournament”) are extracted from the analyzed logical operational expression 4000.

Subsequently, the block relevancy judgment is carried out for each min term based on the characteristic strings 440 of the block #1 and the min terms 4501 extracted in the min term extraction step 3221 (step 3222), by which a judgment result 4502 is outputted. In the example of FIG. 13, since the characteristic strings 440 includes “country-A” and “Championship”, it is judged that two min terms “country-A” and (“Championship” or “tournament”) are satisfied by (the characteristic strings 440 of) the block #1.

Subsequently, the full-text search condition relevancy 4500 of the block #1 regarding the analyzed logical operational expression 4000 is calculated (step 3223). In the example of FIG. 13, based on the block relevancy judgment result 4502 obtained in the min term relevancy judgment step 3222, a total min term number “3” and a relevant min term number “2” are obtained, and “0.67” is obtained from the equation (3) as the full-text search condition relevancy 4500 of the block #1.

As explained above, in the relevant document search system in accordance with the second embodiment of the present invention, the inclusion degree is calculated using not only the relevancy to the contents of the seed text but also the relevancy to the full-text search condition, by which the inclusion degree of each object document (object text) can be calculated taking more precise search conditions (suiting the objective of the search or the intention of the searcher) into consideration.

While both the seed text and the full-text search condition were designated as the search conditions in the above embodiment, it is also possible to let the searcher designate the full-text search condition only. In such cases, the seed text analysis program 130 and the block similarity calculation program 141 shown in FIG. 9 become unnecessary, and the judgment regarding the similarity becomes unnecessary in the relevant block judgment process (step 323c of FIG. 11). In the similarity calculation process (step 222 of FIG. 10), similarity of the text to the full-text search condition can be calculated by methods based on the extended Boolean, by a method disclosed in JP-A-11-154164, etc.

In the following, a third embodiment in accordance with the present invention will be explained in detail. In the third embodiment, characteristic strings are extracted from each block when each document file is registered, and the characteristic strings extracted from each block are previously stored in the magnetic disk unit 103 as a block characteristic string file. The calculation of the inclusion degree is carried out by reading out the block characteristic string file.

The document search system of the third embodiment has almost the same composition as the system of the first embodiment shown in FIG. 1 except for the composition of the magnetic disk unit 103, the registration control program 111 and the inclusion degree calculation control program 133. As shown in FIG. 9, the magnetic disk unit 103 of the third embodiment further stores the block characteristic string file 171. A registration control program 111c of the third embodiment further includes a block partitioning program 140 and a block characteristic string registration program 1200. An inclusion degree calculation control program 1331 of the third embodiment includes a characteristic string read program 1400 instead of the block partitioning program 140 of FIG. 1.

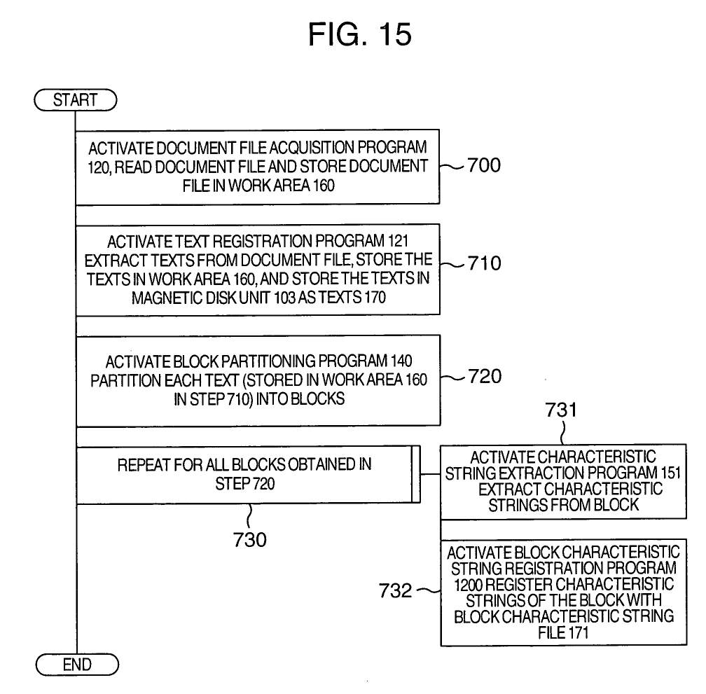

In the following, a process conducted by the registration control program 111c which is different from the first embodiment will be explained referring to FIG. 15. The difference from the first embodiment (FIG. 2) is that the block partitioning program 140, the characteristic string extraction program 151 and the block characteristic string registration program 1200 are executed for generating the block characteristic string file 171 after the execution of the text registration program 121.

The registration control program 111c first activates the document file acquisition program 120, by which a document file stored in the flexible disk 108 is read out via the FDD 104 and stored in the work area 160 (step 700). Subsequently, the text registration program 121 is activated, by which texts are extracted from the document file read out in the step 700 and the extracted texts are stored in the magnetic disk unit 103 as the texts 170 while storing the extracted texts also in the work area 160 (step 710). Subsequently, the block partitioning program 140 is activated, by which each text stored in the work area 160 in the step 710 is partitioned into blocks (step 720).

Subsequently, the following steps 731 and 732 are repeated for all the blocks obtained in the step 720 (step 730). First, the characteristic string extraction program 151 is activated and thereby characteristic strings are extracted from each block (step 731). Subsequently, the block characteristic string registration program 1200 is activated, by which the characteristic strings extracted from each block in the step 731 are registered with the block characteristic string file 171 (step 732).

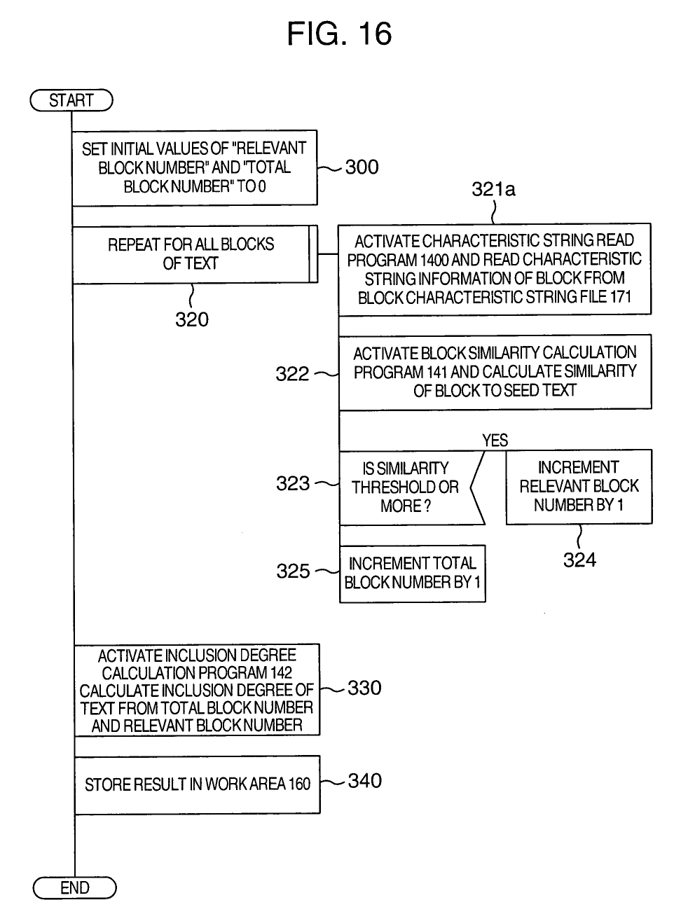

In the following, a process conducted by the inclusion degree calculation control program 1331 which is different from the first embodiment will be explained referring to FIG. 16. The difference from the flow of the first embodiment (FIG. 3) is that the step 310 is deleted and the step 321 is replaced by a step 321a.

The inclusion degree calculation control program 1331 first sets the initial values of the relevant block number and the total block number to 0 (step 300). Subsequently, the following steps 321a-325 are repeated for all the blocks included in a text (step 320).

First, the characteristic string read program 1400 is activated and thereby characteristic strings of a block are read out from the block characteristic string file 171 (step 321a). Subsequently, the block similarity calculation program 141 is activated, by which the similarity of the block to the seed text is calculated by the aforementioned equation (1) (step 322). The block similarity calculated in the step 322 is compared with the seed text relevancy threshold (step 323). If the block similarity is the seed text relevancy threshold or more (YES in the step 323), the block is judged to be a relevant block and the relevant block number is incremented by 1 (step 324) while incrementing the total block number by 1 (step 325). If the block similarity is less than the seed text relevancy threshold (NO in the step 323), only the total block number is incremented by 1 (step 325) without incrementing the relevant block number.

When the steps 321a-325 are finished for all the blocks of the text, the inclusion degree calculation program 142 is activated, by which the inclusion degree of the text regarding the seed text is calculated by the equation (2) based on the relevant block number and the total block number counted in the steps 324 and 325 (step 330). Finally, the inclusion degree of the text regarding the seed text calculated in the step 330 is stored in the work area 160 (step 340).

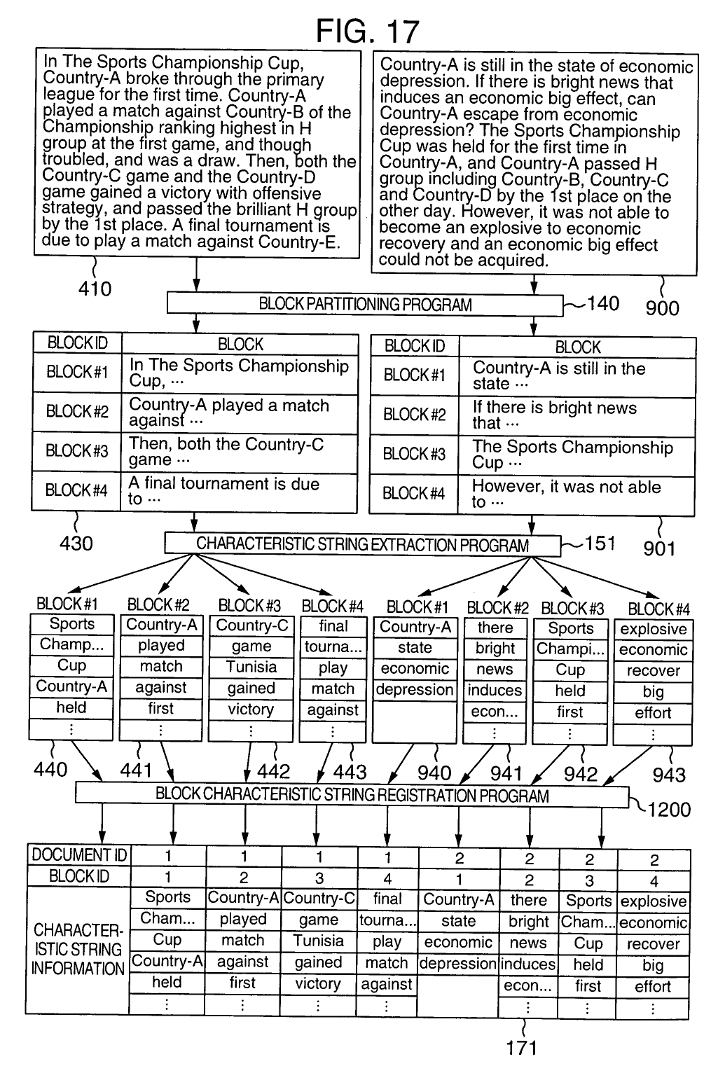

Next, a process flow for registering the characteristic strings of each block with the block characteristic string file 171 of the magnetic disk unit 103 (conducted during the document registration process) will be explained referring to FIG. 17. FIG. 17 shows the process flow for registering the characteristic strings of each block of the documents #1 and #2 with the block characteristic string file 171 when the document #1: “In The Sports Championship Cup, Country-A broke through the primary league for the first time. Country-A played a match against Country-B of the Championship ranking highest in H group at the first game, and though troubled, and was a draw. Then, both the Country-C game and the Country-D game gained a victory with offensive strategy, and passed the brilliant H group by the 1st place. A final tournament is due to play a match against Country-E.” and the document #2: “Country-A is still in the state of economic depression. If there is bright news that induces an economic big effect, can Country-A escape from economic depression? The Sports Championship Cup was held for the first time in Country-A, and Country-A passed H group including Country-B, Country-C, and Country-D by the 1st place on the other day. However, it was not able to become an explosive to economic recovery and an economic big effect could not be acquired.” have been read out by the text read program 131 as a text 410 and a text 900 respectively.

First, the block partitioning program 140 is executed and thereby the text 410 read out by the text read program 131 is partitioned into blocks. In the example of FIG. 17, the partitioning into blocks has been done using periods “.” as separators and thereby a block partitioning result 430 has been obtained. The block partitioning result 430 of FIG. 17 shows that a block #1: “In The Sports Championship Cup, Country-A broke through the primary league for the first time.”, a block #2: “Country-A played a match against Country-B of the Championship ranking highest in H group at the first game, and though troubled, and was a draw.”, a block #3: “Then, both the Country-C game and the Country-D game gained a victory with offensive strategy, and passed the brilliant H group by the 1st place.”, and a block #4: “A final tournament is due to play a match against Country-E.” have been stored in the work area 160.

Subsequently, the characteristic string extraction program 151 is executed and thereby character strings “Sports”, “Championship”, “Cup”, “Country-A”, “broke”, “through”, “primary”, “league”, “first”, and “time” are extracted from the block #1 of the block partitioning result 430 as characteristic strings 440. Then, the block characteristic string registration program 1200 is executed, by which the characteristic strings 440 of the block #1 extracted by the characteristic string extraction program 151 are registered with the block characteristic string file 171 as characteristic strings of the block #1 of the document #1. Together with the characteristic strings 440, a document ID “1” and a block ID “1” are also registered.

Also for the blocks #2-#4, the characteristic string extraction process is carried out by the characteristic string extraction program 151, and characteristic strings (441-443) extracted from each block are registered with the block characteristic string file 171 as characteristic strings of each block of the document #1.

Similarly, also for the document #2 (text 900 read out by the text read program 131), a block partitioning result 901 is obtained by the block partitioning program 140, characteristic strings (940-943) are extracted from each block by the characteristic string extraction program 151, and the extracted characteristic strings are registered by the block characteristic string registration program 1200 with the block characteristic string file 171 as characteristic strings of each block of the document #2.

Incidentally, the document IDs “1” and “2” stored in the block characteristic string file 171 of FIG. 17 correspond to the documents #1 and #2, respectively.

As explained above, in the relevant document search system in accordance with the third embodiment of the present invention, the block characteristic string file 171 is previously generated when the documents are registered. Therefore, the need of executing the block partitioning process (for each text) and the characteristic string extraction process (for each block) on each document search is eliminated, by which the calculation of the inclusion degree can be done at high speed on each document search even for large amounts of texts.

Incidentally, while the calculation of the similarity was done in the above embodiment by activating the text read program 131 and reading the texts 170, the similarity calculation can also be done without activating the text read program 131, that is, by calling the characteristic string read program 1400 and using values (characteristic strings) of the block characteristic string file 171 read by the characteristic string read program 1400. By the method, the need of reading the texts 170 for the similarity calculation is eliminated and thereby memory usage is reduced.

As set forth hereinabove, in the embodiments in accordance with the present invention, not only the similarity of each object document (object text) to the seed text but also the inclusion degree of each object document to the seed text (indicating the ratio of relevant contents (contents of the object document relevant to the seed text) to the whole object document) is calculated. By the inclusion degree, whether the object document has the “overall similarity” to the seed text (the whole object document is similar to the contents of the seed text) or the “partial similarity” to the seed text (part of the object document is similar to the contents of the seed text) can be judged easily and the document search can be carried out more efficiently according to the objective of the search.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A document search method for finding a document relevant to a search condition from object documents as search objects, comprising the steps of:
acquiring a seed text which is inputted as the search condition;
partitioning the object document into a plurality of blocks;
calculating similarity of each block of the object document to the seed text;
comparing the calculated similarity with a preset threshold value and thereby judging whether or not each block is relevant to the seed text; and
calculating an inclusion degree of the object document including the blocks regarding the seed text based on the result of the judgment.

2. The document search method according to claim 1, further comprising the steps of:
calculating similarity of the object document to the seed text; and
displaying the calculated similarity of the object document to the seed text and the calculated inclusion degree of the object document regarding the seed text.

3. A document search device for finding a relevant document from object documents as search objects, comprising:
a seed text acquisition module which acquires a seed text as a search condition;
a partitioning module which partitions the object document into a plurality of blocks;
a similarity calculation module which calculates similarity of each block of the object document to the seed text;
an inclusion degree calculation module which compares the calculated similarity of each block with a preset threshold value, thereby judges whether or not each block is relevant to the seed text, and calculates an inclusion degree of the object document including the blocks regarding the seed text based on the result of the judgment.

4. The document search device according to claim 3, further comprising:
a full-text search condition acquisition module which acquires a full-text search condition to be used for a full-text search of the object documents;
a full-text search condition analysis module which analyzes the acquired full-text search condition; and
a full-text search condition relevancy calculation module which executes a full-text search to each block based on the analyzed full-text search condition and thereby calculates relevancy of each block to the full-text search condition, wherein:
the inclusion degree calculation module calculates the inclusion degree of the object document regarding the seed text by use of the full-text search condition relevancy of each block of the object document calculated by the full-text search condition relevancy calculation module and the similarity of each block of the object document to the seed text calculated by the similarity calculation module.

5. The document search device according to claim 3, further comprising a display module which places the object documents in order of the inclusion degree regarding the seed text or in order of similarity to the seed text and displays the order of the object documents.

6. A computer-readable record medium storing a program for instructing a computer etc. to execute a relevant document search method for finding a relevant document from object documents as search objects, wherein the relevant document search method comprises the steps of:
acquiring a seed text as a search condition for searching the object documents;
partitioning the object document into a plurality of blocks;
calculating similarity of each block of the object document to the seed text;
comparing the calculated similarity with a preset threshold value;
judging whether or not each block is relevant to the seed text based on the comparison and thereby counting the number of blocks relevant to the seed text; and
calculating an inclusion degree of the object document regarding the seed text based on the counted number of the relevant blocks.

7. A document relevancy judgment method for judging relevancy of a previously stored object document to a seed text as a search condition, comprising the steps of:
partitioning the object document into a plurality of blocks;
calculating similarity of each block of the object document to the seed text;
comparing the calculated similarity with a preset threshold value and thereby judging whether or not each block is relevant to the seed text;
counting the number of blocks relevant to the seed text based on the judgment; and
calculating an inclusion degree of the object document including the blocks regarding the seed text based on the counted number of the relevant blocks.

8. The document relevancy judgment method according to claim 7, further comprising the steps of:
calculating similarity of the object document to the seed text;
displaying at least one of the calculated similarity of the object document to the seed text and the calculated inclusion degree of the object document regarding the seed text.

9. The document relevancy judgment method according to claim 7, further comprising the steps of:
acquiring a full-text search condition for a full-text search of the object document;
calculating relevancy of each block of the object document to the acquired full-text search condition; and
judging whether or not each block of the object document is relevant to the search conditions by use of the calculated relevancy of the block to the full-text search condition and the calculated similarity of the block to the seed text.

10. A relevant document search method for finding a document from object documents as search objects, comprising the steps of:
acquiring a full-text search condition which is inputted as a search condition;
partitioning the object document into a plurality of blocks;
calculating similarity of each block of the object document to the full-text search condition;
comparing the calculated similarity with a preset threshold value and thereby judging whether or not each block is relevant to the full-text search condition; and
calculating an inclusion degree of the object document including the blocks regarding the full-text search condition based on the result of the judgment.

11. The relevant document search method according to claim 10, further comprising the steps of:
calculating similarity of the object document to the full-text search condition; and
displaying the calculated similarity of the object document to the full-text search condition and the calculated inclusion degree of the object document regarding the full-text search condition.

12. The document search method according to claim 1, further comprising the steps of:
extracting character strings from the acquired seed text; and
extracting character strings from each block of the object document, wherein:
the similarity of each block of the object document to the seed text is calculated by comparing the character strings extracted from each block with the character strings extracted from the seed text.

13. The document search method according to claim 12, further comprising the steps of:
regarding each block as a relevant block to the seed text if the calculated similarity of the block is higher than a preset value;
counting the number of blocks judged as the relevant blocks; and
storing the counted number of relevant blocks.

14. The document search method according to claim 13, wherein the inclusion degree of the object document regarding the seed text is calculated from the stored number of relevant blocks and the total number of blocks included in the object document.

15. The document search device according to claim 4, further comprising a characteristic string extraction module which extracts characteristic strings from the seed text, wherein:
the characteristic string extraction module extracts characteristic strings also from each block of the object document, and
the similarity calculation module calculates the similarity of each block by comparing the characteristic strings extracted from the block with the characteristic strings extracted from the seed text, and
the inclusion degree calculation module regards each block as a relevant block if the similarity of the block is higher than a preset value and the full-text search condition relevancy of the block is higher than a preset value, counts the number of the relevant blocks included in the object document, and calculates the inclusion degree of the object document by use of the counted number of relevant blocks and the total number of blocks included in the object document.

16. A relevant document search device for finding a relevant document from object documents as previously registered search objects, comprising:
a partitioning module which partitions the object document into a plurality of blocks;
a characteristic string extraction module which extracts characteristic strings from each block of the object document;
a block characteristic string storage module which stores the extracted characteristic strings associating them with each block;
a seed text acquisition module which acquires a seed text as a search condition;
a similarity calculation module which calculates similarity of each block to the seed text by comparing the characteristic strings of the block stored in the block characteristic string storage module with characteristic strings extracted from the seed text by the characteristic string extraction module;
an inclusion degree calculation module which counts the number of blocks having the similarity higher than a preset value and calculates an inclusion degree of the object document regarding the seed text based on the counted number of blocks and the total number of blocks included in the object document.

17. The relevant document search device according to claim 16, further comprising an output module which outputs at least one of the similarity calculated by the similarity calculation module and the inclusion degree calculated by the inclusion degree calculation module.

18. A program for letting a document search system execute a process for finding a document relevant to a search condition from object documents as search objects, wherein the process comprises the steps of:
acquiring a seed text as the search condition;
partitioning the object document into a plurality of blocks;
calculating similarity of each block of the object document to the acquired seed text;
calculating an inclusion degree of the object document regarding the seed text by judging whether or not the similarity of each block of the object document is higher than a preset value.

19. The program according to claim 18, wherein the process further comprises the steps of:
analyzing a full-text search condition to be used for a full-text search of the object documents;
executing a full-text search to each block based on the analyzed full-text search condition and thereby calculating relevancy of each block to the full-text search condition, wherein:
the inclusion degree calculation step calculates the inclusion degree of the object document regarding the seed text by use of the full-text search condition relevancy of each block of the object document calculated in the full-text search condition relevancy calculation step and the similarity of each block of the object document to the seed text calculated in the similarity calculation step.

20. The program according to claim 19, wherein the process further comprises the steps of:
placing the object documents in order of the inclusion degree regarding the seed text or in order of similarity to the seed text; and
displaying the order of the object documents.
